(19) United States
(12) Patent Application Publication
(10) Pub. No.: US 2010/0106732 A1
(43) Pub. Date: Apr. 29, 2010

(54) Identifying Visually Similar Objects

(75) Inventors: Antoine Joseph Atallah, Bellevue, WA (US); Noaa Avital, Seattle, WA (US); Alex David Weinstein, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/260,433

(22) Filed: Oct. 29, 2008

(51) Int. Cl. G06F 17/30; G06F 7/00

(52) U.S. Cl. 707/749; 707/E17.015; 707/E17.02

(57) ABSTRACT

Methods, systems, and computer-readable media for finding similarities between visual objects using keywords and computerized visual image analysis are provided. A visual object may be provided as an input. A group of visual objects sharing keywords with the visual object may be generated for further analysis. The visual similarity of this group of visual objects may then be determined using computerized visual analysis. A group of visual objects that have the highest similarity rank, as determined by the computerized visual analysis, may then be displayed.

### BACKGROUND

Vast collections of media objects, such as photographs, videos, audio files and clip art, are presently available to users through online databases. Users may access the collections by navigating to a web site associated with one or more collections and submitting a search query. In response to the search query, the web site will present media objects that are responsive to the query. In some instances, the web site determines that a media object is responsive to a query by evaluating keywords that have been assigned to a visual object.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to finding similarities between visual objects by using a combination of keywords associated with the visual objects and computerized analysis of the visual objects. As a starting point, a visual object that has been indexed by a search engine is selected. The search engine generates a group of indexed visual objects that share keywords, and/or other characteristics with the selected visual object. Each of the indexed visual objects is then ranked according to similarity with the selected visual object. The ranking is based, at least in part, on results of a computerized visual analysis of the indexed visual objects and the selected visual object. Other factors such as number of keywords in common, common author, and date of creation can be considered when ranking the objects. Some or all of the visual objects in the group of visual objects may then be presented to the user that selected the visual object in the first place. Thus, the user may select a first visual object as a search criteria and embodiments of the present invention will present one or more similar objects.

### BRIEF DESCRIPTION OF THE DRAWINGS

The present invention is described in detail below with reference to the attached drawing figures, wherein:

FIG. 1 is a block diagram of an exemplary computing environment suitable for implementing embodiments of the present invention;

FIG. 2 is a block diagram of an exemplary computing system suitable for implementing embodiments of the present invention;

FIGS. 3A-C show an exemplary user interface for receiving search criteria from a user and presenting visual objects that are responsive to the search criteria, in accordance with embodiments of the present invention;

FIG. 4. is a flow diagram showing a method of finding similar visual objects within a plurality of visual objects in accordance with embodiments of the present invention; and

FIG. 5 is a flow diagram showing a method for ranking visually similar objects in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention generally relate to finding similarities between visual objects by using a combination of descriptive information (e.g., keywords, categorization, object creator, date of creation) associated with the visual objects and computerized analysis of the visual objects. In one embodiment, a visual object is provided as an input. A group of visual objects sharing descriptive information with the visual object may be generated by a search engine. The visual similarity of this group of visual objects is then determined using computerized visual analysis. A group of visual objects that have the highest similarity rank, based, at least in part, on the computerized visual analysis, may then be displayed.

Accordingly, in one embodiment, one or more computer-readable media having computer-executable instructions embodied thereon for performing a method of finding similar visual objects within a plurality of visual objects is provided. The method includes storing the plurality of visual objects in a data store. Each visual object within the plurality of visual objects is associated with one or more keywords. The method also includes receiving a first selection of a first visual object, wherein the first visual object is one of the plurality of visual objects. The method also includes generating a matching plurality of visual objects that includes one or more visual objects from the plurality of visual objects that are associated with at least one keyword that is also associated with the first visual object. The method farther includes generating a similarity rank for the each visual object in the matching plurality of visual objects using a computerized visual analysis, wherein the similarity rank describes how similar a visual object is to the first visual object. The method further includes displaying a threshold number of visual objects having above a threshold similarity rank.

In another embodiment, a computerized system, including one or more computer-readable media, for finding similar visual objects within a plurality of visual objects is provided. The system includes a search engine for indexing the plurality of visual objects according to keywords associated with each visual object in the plurality of visual objects, receiving a first visual object within the plurality of visual objects as a search criteria, and generating a matching plurality of visual objects, wherein the matching plurality of visual objects is a subset of the plurality of visual objects having one or more keywords in common with the first visual object. The system also includes a visual analysis component for performing a computerized image analysis on at least the first visual object and the each visual object in the matching plurality of visual objects, wherein a result of a computerized visual analysis is associated with the each visual object on which the computerized visual analysis is performed. The system further includes a visual similarity component for determining a degree of similarity between the first visual object and the each visual object in the matching plurality of visual objects using the results of the computerized image analysis. The system also includes a data store for storing the plurality of visual objects and information associated with the each visual object within the plurality of visual objects.

In yet another embodiment, a method for ranking visually similar objects is provided. The method includes receiving information associated with one or more visual objects that match a first visual object. The one or more visual objects match the first visual object because descriptive information associated with the first visual object is similar to descriptive information associated with the one or more visual objects and ranking each of the one or more visual objects according to visual similarity with the first visual object using, at least, results of a computerized visual analysis. The method also includes displaying a threshold number of most similar visual objects from the one or more visual objects.

Having briefly described an overview of embodiments of the present invention, an exemplary operating environment suitable for use in implementing embodiments of the present invention is described below.

### Exemplary Operating Environment

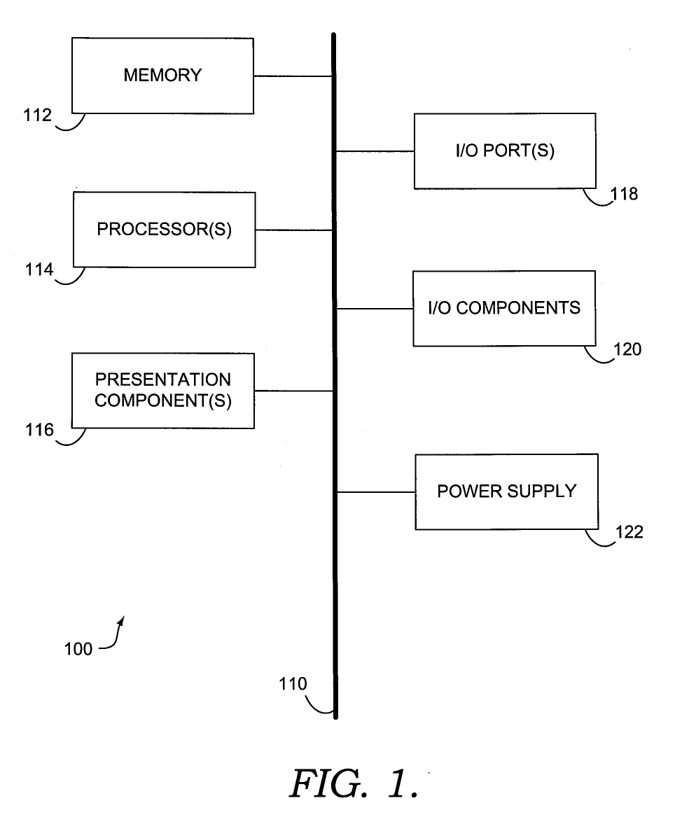

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary System Architecture

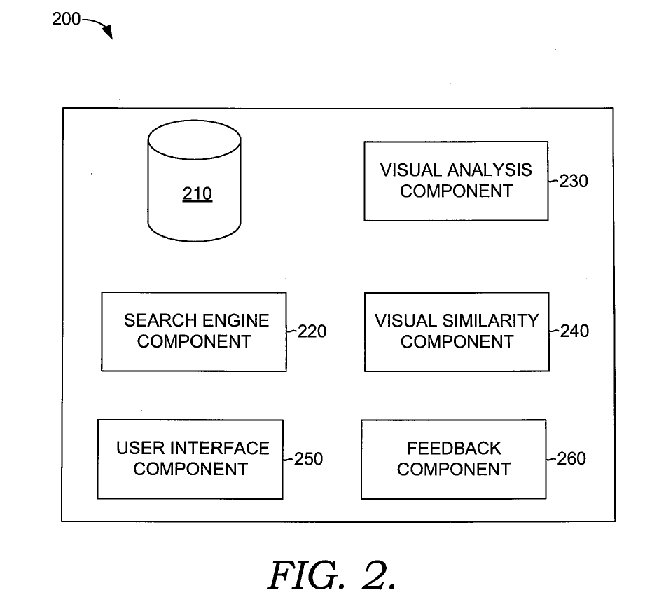

Turning now to FIG. 2, a block diagram is illustrated that shows an exemplary computing system architecture 200 suitable for finding similarities between visual objects, in accordance with an embodiment of the present invention. It will be understood and appreciated by those of ordinary skill in the art that the computing system architecture 200 shown in FIG. 2 is merely an example of one suitable computing system and is not intended to suggest any limitation as to the scope of the use or functionality of the present invention. Neither should the computing system architecture 200 be interpreted as having any dependency or requirement related to any single component/module or combination of components/modules illustrated therein.

Computing system architecture 200 includes a data store 210, a search engine component 220, a visual analysis component 230, a visual similarity component 240, a user interface component 250, and a feedback component 260. Computing system architecture 200 may reside on a single computing device, such as computing device 100 shown in FIG. 1. In the alternative, computing system architecture 200 may reside in a distributed computing environment that includes multiple computing devices coupled with one another via one or more networks. Such networks may include, without limitation, one or more local area networks (LANs) and/or one or more wide area networks (WANs). Such network environments are commonplace in offices, enterprise-wide computer networks, intranets, and the Internet. Accordingly, the network, or combination of networks, is not further described herein.

Data store 210 stores a collection of visual objects and a plurality of descriptive information associated with each visual object in the collection. Descriptive information that may be associated with an individual visual object include a unique object identification, one or more keywords, date of creation, vendor, author, descriptive category, and usage history. The usage history may include the number of times a visual object has been selected, the users that have selected the visual object, the other objects selected by the user in response to the same query, and other information. The visual objects are electronic files that, when presented on a display device by a compatible program, produce visual content that is observable with human eyes. Examples of visual objects include clip art, videos, digital photographs, icons, documents, presentations, spreadsheets, and drawings. The content of the visual object may include communicative content such as text. The data store 210 may be in the form of a data base or any other form capable of storing a collection of visual objects and associated data.

Search engine component 220 identifies visual objects that are responsive to search criteria and returns those visual objects, or links to the visual objects, as search results to a user submitting the search criteria. In one embodiment, the search engine component 220 indexes a plurality of visual objects. The index may include descriptive information associated with each of the indexed visual objects, results of computerized visual analysis for one or more of the visual objects in the index, and feedback information for visual objects. As described in more detail subsequently, feedback may include data regarding user interactions with the visual objects.

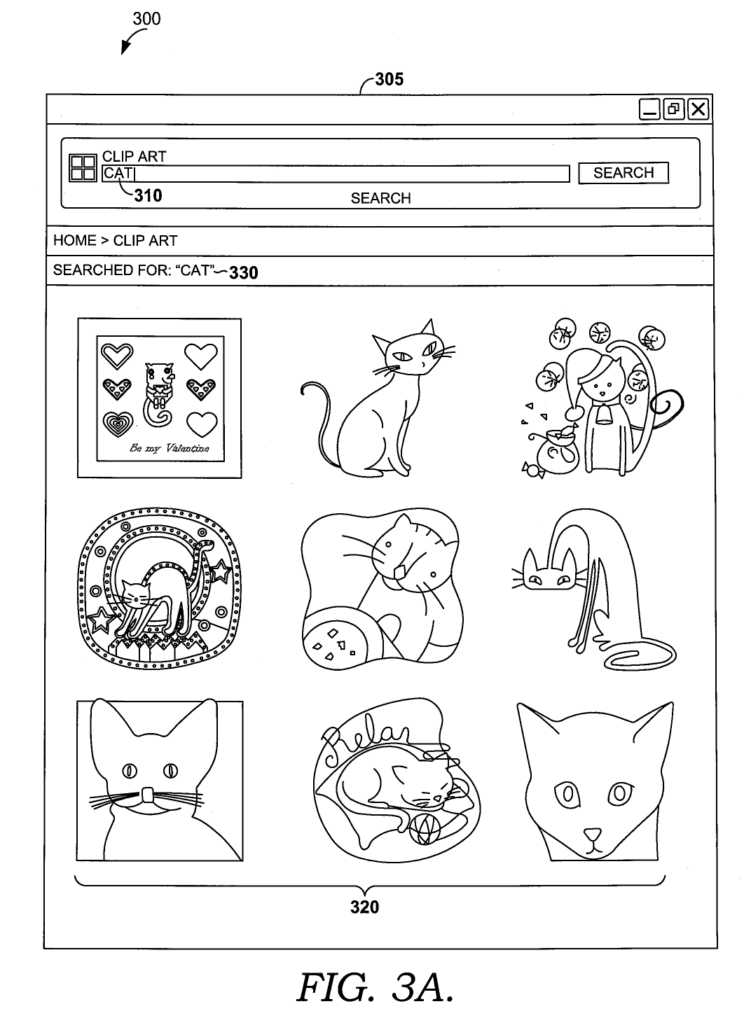

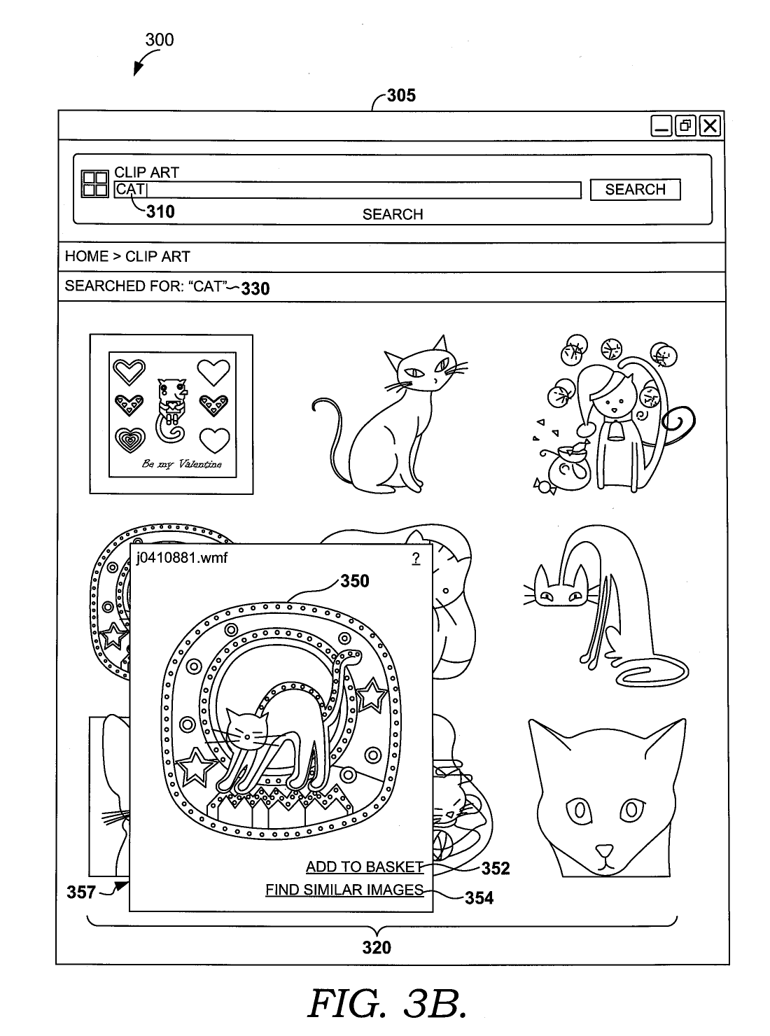

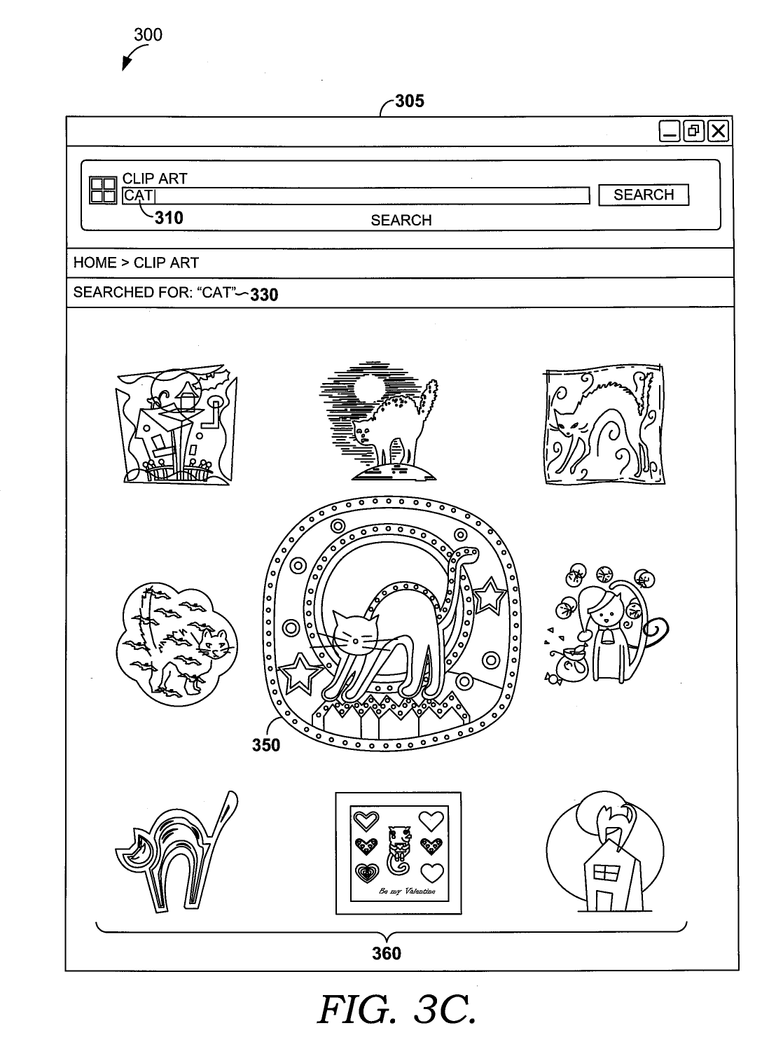

In one embodiment, the search engine component 220 receives alpha numeric search criteria and displays one or more visual objects that are associated with descriptive information, such as keywords, that match the alpha numeric search criteria. In one embodiment, the search engine component 220 presents an option that allows a user to request additional visual objects that are similar to a selected visual object. The search engine component 220 may interact with user interface component 250 to present an interface capable of receiving search criteria and presenting search results. An embodiment of such a user interface is illustrated in FIG. 3A.

Turning now to FIG. 3A, a user interface 300 suitable for receiving search criteria and presenting visual objects that are responsive to the search criteria is shown, in accordance with an embodiment of the present invention. In one embodiment, user interface 300 is accessed by a user over the Internet and viewed using a browser program. User interface 300 is initially displayed within a primary application window 305. User interface 300 contains search input box 310. In this case, the word “cat” is entered into search input box 310 by a user. In one embodiment, a search engine, such as search engine component 220, returns a first group of visual objects 320 that are responsive to the search criteria “cat.” As can be seen, the first group of visual objects 320 includes visual objects containing cats. As described previously, in one embodiment the visual objects are identified by using keywords associated with the visual objects. Descriptive information in addition to, or instead of, keywords may be used to generate search results. Primary application window 305 contains a subject heading 330 that reminds the user of the search criteria used to select the first group of visual objects 320.

Turning now to FIG. 3B, a user interface 300 showing a response to a user selection of a visual object is shown, in accordance with an embodiment of the present invention. In response to selecting visual object 350, user interface 300 presents visual object 350 in a secondary window 357. The secondary window 357 is presented on top of primary application window 305. Secondary window 357 contains an enlarged version of visual object 350 and two additional icons that allow the user to choose additional functions. The first icon is the “add to basket” icon 352 that allows the user to add visual object 350 to the visual objects basket. The second icon, the “find similar objects” icon 354 allows the user to request additional objects that are similar to visual object 350. The similar visual objects may be identified using embodiments of the present invention that are explained in more detail herein.

Returning now to FIG. 2, upon receiving an indication that visual objects similar to a selected visual object are requested, the search engine component 220 may identify a matching plurality of visual objects that is similar to the selected visual object. The search engine component 220 identifies similar visual objects from its index by comparing the descriptive information, such as keywords, associated with the selected visual object with descriptive information associated with visual objects in an index. In one embodiment, the matching plurality of visual objects, or information regarding the matching plurality of visual objects, is passed to visual analysis component 230 for further analysis. As explained subsequently, the visual analysis component 230 may determine which of the matching plurality of visual objects is most similar to the selected visual object, and send the results of this determination to the search engine component 220. The search engine component 220 may then display the similar visual objects, or links to the similar visual objects, to the user that requested them.

Visual analysis component 230 uses one or more methods of computerized visual analysis to analyze visual objects for similarity. A computerized visual analysis of a visual object may create a map of the visual object. For example, the map may locate areas of color, shapes, and sections of color of a certain size and describe these in a result. The similarity of different objects can be determined by analyzing the results of the computerized visual analysis. For example, it can be determined that two visual objects are similar because they contain similar colors and similar visual patterns. In one embodiment, the computerized visual analysis uses a Kohonen Neural Network Visual Object Analysis. In another embodiment, the Kolmogorov-Smimov test is used. In another embodiment, both methods are used to analyze visual objects. Other methods of computerized visual analysis may also be used alone or in combination with other methods. The results of the computerized analysis may be described as a digital signature for the visual object.

The results of the computerized visual analysis may be stored in data store 210. In one embodiment, the results of the computerized analysis are stored in the index used by search engine component 220. Thus, each visual object in the index would be associated with results of computerized visual analysis. In one embodiment, each indexed visual object is analyzed prior to receiving a request to find a similar visual object and the results of the visual analysis are stored in the index. In another embodiment, visual objects are analyzed on an as needed basis. Even when analyzed on an as needed basis, the results could be fed back to search engine component 220 to be stored for future use in an index. Thus, a hybrid system may be set up where visual objects are not intentionally preprocessed, but the results are stored so that the visual object does not need to be analyzed twice. If a computerized visual analysis has been performed on a visual object, the search engine component 220 may pass the results of this analysis to visual analysis component 230, or visual similarity component 240. If results are passed to the visual analysis component 230, then the visual object is not reanalyzed.

Visual similarity component 240 uses the results of the computerized visual analysis to rank the similarity of visual objects provided by the search engine component 220 to the selected visual object. As stated previously, visual objects having similar colors and similar shapes would be ranked as more similar, whereas visual objects having different colors and different shapes would be less similar. The rank could be relative to the visual objects analyzed. For example, a group of 50 visual objects provided based on keywords could be ranked from 1-50 based on the degree of similarity to the selected visual object. In another embodiment, the group of visual objects could be ranked in absolute terms. For example, in a group of 50 objects submitted based on keywords, 5 of them could be 90% similar, 10, 80% similar, 3, 75% similar, and so on.

The visual similarity component 240 may use descriptive information associated with the visual objects, in addition to the results of the computerized visual analysis to tank the similarity of visual objects. For example, the ranking could take the number of keywords in common or the descriptive category of the one or more similar visual objects into consideration when generating the similarity ranking.

The visual similarity component 240 may present above a threshold number of visual objects to user interface component 250 to be presented as search results to a user. In one embodiment, the ten most similar visual objects are presented. In another embodiment, objects having a degree of similarity above a threshold are presented.

User interface component 250 may receive search criteria, present search results consisting of visual objects or links to visual objects, and receive the selection of a visual object for which similar visual objects are desired. The user interface component 250 may cause the user interface to be displayed on a display device attached to the computing device on which the previously described components are operating, or transmit the user interface over a network to a separate computing device. The presentation of similar visual objects, which is the output of embodiments of the present invention, is presented in FIG. 3C.

Turning now to FIG. 3C, a user interface 300 showing a selected visual object 350 and a group of suggested visual objects that are related to the selected visual object 350 is shown, in accordance with an embodiment of the present invention. FIG. 3C shows the response to the selection of the “find similar objects” icon 354 in FIG. 3B. As can be seen, the second group of visual objects 360 in FIG. 3C is different than the first group of visual objects 320 in FIG. 3B. The first group of visual objects 320 was based on an alphanumeric search term “cat.” As described previously, the second group of visual objects 360 includes visual objects determined to be similar to the selected visual object 350 by evaluating the results of a computerized visual analysis of the selected visual object 350 and other visual objects having the same keywords as the selected visual object.

Returning now to FIG. 2, feedback component 260 provides feedback regarding the user's selection of visual objects to search engine component 220, or other components containing computer learning capabilities. A component with computer learning capabilities uses user behavior to evaluate relationships between items, such as visual objects or keywords in a data store. For example, feedback component 260 may provide an indication that a similar visual object was selected in response to a selected visual object as input. The search engine component 220 may take this information and strengthen the relationship between the two visual objects. In the future, the search engine may present these two visual objects as more similar or related. Objects having a strengthened relationship in the search engine may be considered more closely related. In another embodiment, the indication is used by the search engine to strengthen the relationship between keywords associated with the selected visual object and a similar visual object selected by a user.

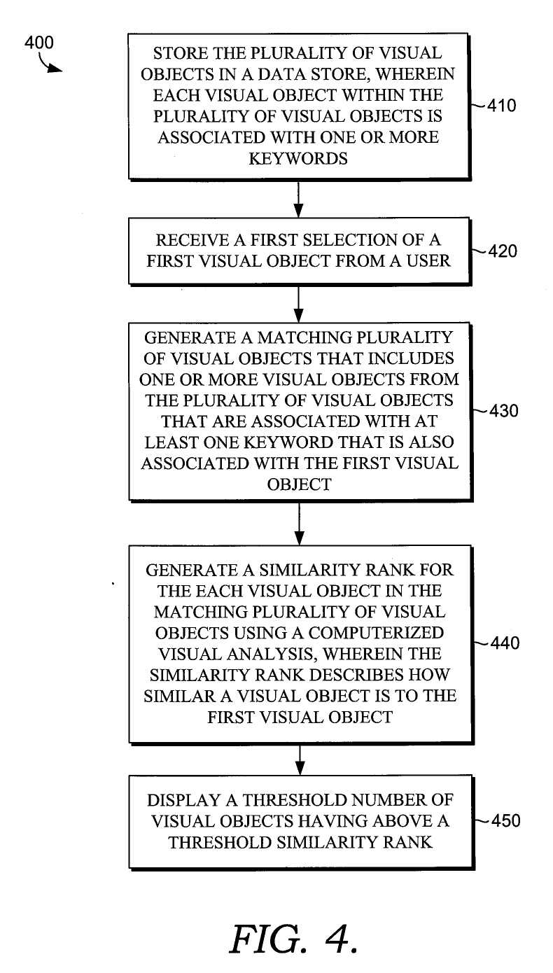

Turning now to FIG. 4, a method of finding similar visual objects within a plurality of visual objects is shown, according to an embodiment of the present invention. At step 410, a plurality of visual objects is stored in a data store, such as data store 210. Each visual object within the plurality of visual objects is associated with one or more keywords. Additional information, such as a unique identifier, descriptive information, user feedback information, and results of a computerized visual analysis may be stored in association with each of the visual objects within the plurality of visual objects.

At step 420, a first selection of a first visual object is received. The first visual object is one of the plurality of visual objects stored in the data store. The first visual object may be selected through a user interface displaying one or more visual objects. As explained previously, the one or more visual objects may have been displayed as the result of a search. However, the one or more visual objects do not need to be initially presented in response to a search. For example, the one or more visual objects could be displayed as a user navigates a hierarchical organization of visual objects.

At step 430, a matching plurality of visual objects is generated. The matching plurality of visual objects includes one or more visual objects from the plurality of visual objects that is associated with at least one keyword that is also associated with the first visual object. Thus, the matching plurality of visual objects is determined to match based on a keyword analysis. As described previously, the keyword analysis may be performed by a search engine using the indexed keywords. Additional descriptive information may also be used to

At step 440, a similarity rank is generated for each visual object in the matching plurality of visual objects using a computerized visual analysis. Additional information, such as the descriptive information, may also me used to generate the similarity rank. The similarity rank describes how similar a visual object is to the first visual object. As described previously, a computerized visual analysis may generate an image map or other result that describes the colors and shapes within the visual image. Also as described previously, the rank may be relative to other visual objects analyzed or an absolute number describing the similarity with the selected visual objects.

At step 450, a threshold number of visual objects having above a threshold similarity rank are displayed. Visual objects with a similarity rank above a threshold may be displayed on a user interface presented to the user. An example of such a user interface is described in FIG. 3C. If a user selects one of these displayed visual objects, feedback may be provided to a search engine, or other component with computer learning functionality, indicating the visual object was selected in response to the selected visual object. This information may be used by the search engine to strengthen the relationship between keywords associated with the originally selected visual object and the second selected visual object. In another embodiment, the feedback is used to strengthen the relationship between the selected visual object and the chosen visual object.

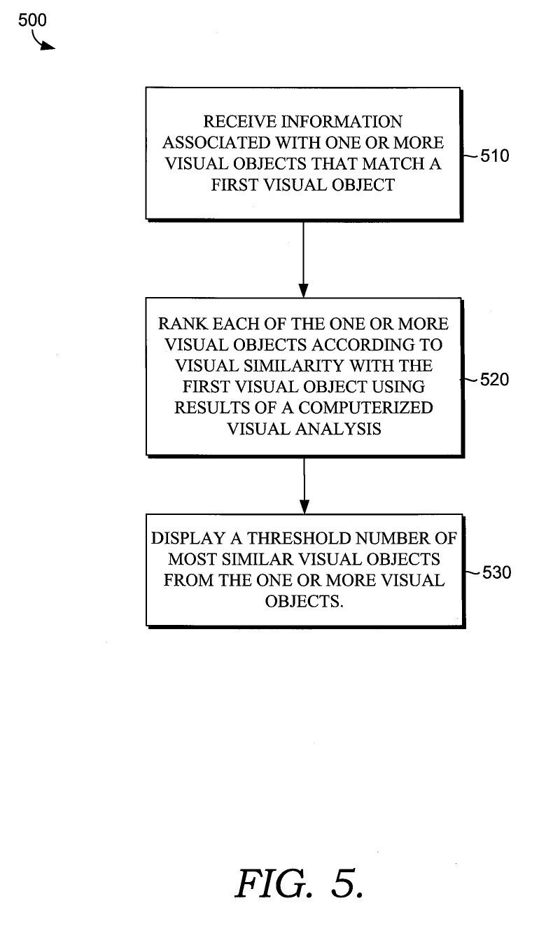

Turning now to FIG. 5, a method for ranking visually similar objects is shown, in accordance with an embodiment of the present invention. At step 510, information associated with one or more visual objects that match a first visual object is received. The one or more visual objects match the first visual object because descriptive information associated with the first visual matches descriptive information associated with the one or more visual objects. The information received may include the results of a computerized visual analysis for each of the one or more visual objects. Descriptive information for the one or more visual objects may also be included in the information.

At step 520, each of the one or more visual objects are ranked according to visual similarity with the first visual object using results of a computerized visual analysis. As described previously, the information associated with the one or more visual objects may include the results of the computerized visual analysis for the one or more visual objects and the first visual object. This information may be used to rank the one or more visual objects according to visual similarity with the first visual object. In another embodiment, the computerized visual analysis is performed on any of the one or more visual objects for which analysis results are not provided. The similarity rank may also be based, in part, on the descriptive information.

At step 530, a threshold number of the most similar visual objects from the one or more visual objects are displayed. The threshold number could be a number of visual objects (e.g., the ten most similar visual objects). The threshold number could also be a number of visual objects with above a threshold degree of similarity. For example, all visual objects with a similarity rank above 90% could be presented.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well-adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of finding similar visual objects within a plurality of visual objects, the method comprising:
storing the plurality of visual objects in a data store, wherein each visual object within the plurality of visual objects is associated with one or more keywords;
receiving a first selection of a first visual object, wherein the first visual object is one of the plurality of visual objects;
generating a matching plurality of visual objects that includes one or more visual objects from the plurality of visual objects, wherein the matching plurality of visual objects are associated with at least one keyword that is also associated with the first visual object;
generating a similarity rank for the each visual object in the matching plurality of visual objects using a computerized visual analysis, wherein the similarity rank describes how similar a visual object is to the first visual object; and
displaying a threshold number of visual objects having above a threshold similarity rank.

2. The media of claim 1, wherein each of the plurality of visual objects includes visual content, and the one or more keywords describe the visual content.

3. The media of claim 1, wherein the method further includes storing results of the computerized visual analysis in association with a corresponding visual object.

4. The media of claim 1, wherein the method further includes:
receiving a second selection of a displayed visual object from the threshold number of visual objects; and
generating behavioral feedback for a search engine that indexes the plurality of visual objects, wherein the behavioral feedback is used by the search engine to strengthen an association between the first visual object and the displayed visual object.

5. The media of claim 1, wherein the method further includes:
receiving a second selection of a displayed visual object from the threshold number of visual objects; and
generating behavioral feedback for a search engine that indexes the plurality of visual objects, wherein the behavioral feedback is used by the search engine to strengthen an association between keywords associated with the first visual object and the displayed visual object.

6. The media of claim 1, wherein the similarity rank is generated using the computerized visual analysis and descriptive information associated with the each visual object in the matching plurality of visual objects.

7. The media of claim 1, wherein the method further includes:
receiving a search query from a user;
generating search results based on keywords associated with the plurality of visual objects; and
displaying the search results to the user, wherein the search results include the first visual object.

8. A computerized system, including one or more computer-readable media, for finding similar visual objects within a plurality of visual objects, the system comprising:
a search engine for:
(1) indexing the plurality of visual objects, wherein keywords are associated with each visual object in the plurality of visual objects,
(2) receiving a first visual object within the plurality of visual objects as a search criteria,
(3) generating a matching plurality of visual objects, wherein the matching plurality of visual objects are a subset of the plurality of visual objects having one or more keywords in common with the first visual object;
a visual analysis component for performing a computerized image analysis on at least the first visual object and the each visual object in the matching plurality of visual objects, wherein a result of a computerized visual analysis is associated with the each visual object on which the computerized visual analysis is performed;
a visual similarity component for determining a degree of similarity between the first visual object and the each visual object in the matching plurality of visual objects using the result of the computerized image analysis; and
a data store for storing the plurality of visual objects and information associated with the each visual object within the plurality of visual objects.

9. The system of claim 8, wherein the information in the data store includes one or more of keywords that describe visual content, identification information, and the result.

10. The system of claim 8, wherein the plurality of visual objects include one or more of:
a video;
a presentation;
a web page;
a clip art,
a picture,
a digital photograph,
a document containing visually analyzable elements, and
a spreadsheet containing visually analyzable elements.

11. The system of claim 8, wherein the system further includes a display component for displaying a threshold number of visual objects that most closely match the first visual object.

12. The system of claim 11, wherein the system further includes a feedback component that provides user feedback to the search engine that allows the search engine to strengthen a relationship between visual objects within the plurality of visual objects.

13. The system of claim 12, wherein the feedback causes the search engine to strengthen the relationship between the one or more keywords associated with the first visual object and a second visual object from the threshold number of visual objects.

14. A method for ranking visually similar objects, the method comprising:
receiving information associated with one or more visual objects that match a first visual object, wherein the one or more visual objects match the first visual object because descriptive information associated with the first visual object is similar to descriptive information associated with the one or more visual objects;
ranking each of the one or more visual objects according to visual similarity with the first visual object using, at least, results of a computerized visual analysis; and
displaying a threshold number of similar visual objects from the one or more visual objects.

15. The method of claim 14, wherein the one or more visual objects are received from a search engine that received a selection of the first visual object and determined the one or more visual objects match the first visual object based on the one or more keywords.

16. The method of claim 14, wherein the information includes results of the computerized visual analysis for each of the one or more visual objects and the first visual object.

17. The method of claim 16, wherein the method further includes performing the computerized visual analysis on each visual object in the one or more visual objects and storing a result of the computerized visual analysis in association with the each visual object analyzed prior to receiving the information.

18. The method of claim 14, wherein the descriptive information includes one or more of keywords, vendor, date of creation, descriptive category, author, and size.

19. The method of claim 14, wherein the method further includes performing the computerized visual analysis on each of the one or more visual objects and the first visual object.

20. The method of claim 14, wherein the method further includes:
receiving a selection of one of the threshold number of the most similar visual objects; and
providing user feedback to a search engine that allows the search engine to strengthen a relationship between keywords associated with the first visual object and the one of the threshold number of the most similar visual objects.
